(19) United States
(12) Patent Application Publication
(10) Pub. No.: US 2026/0205435 A1
(43) Pub. Date: Jul. 16, 2026

(54) METHODS AND APPARATUSES FOR DISCOVERING AN ADDRESS OF A BASE STATION

(71) Applicant: TELEFONAKTIEBOLAGET LM ERICSSON (PUBL), Stockholm (SE)

(72) Inventors: Sera Kang, Seoul (KR); Karin Hedèn, Sundbyberg (SE); Angelo Centonza, Torrenueva Costa (ES)

(21) Appl. No.: 19/137,700

(22) PCT Filed: Nov. 16, 2023
(86) PCT No.: PCT/EP2023/082003

§ 371 Date: Jun. 11, 2025

(30) Foreign Application Priority Data
Dec. 16, 2022 (WO) PCTEP2022086430

(51) Int. Cl. H04L 61/103

(52) U.S. Cl. CPC H04L 61/103

(57) ABSTRACT

A method performed by a first BS in a network, for discovering an address of a second BS in the network via a network node in the network, the method comprising: sending, to the network node, an address request message which includes a first list with one or more pairs of an address of the first BS and a corresponding sharing identifier; and receiving, from the network node, an address response message which includes a second list with one or more pairs of an address of the second BS and a corresponding sharing identifier. In the case of network sharing, by using the addresses and the corresponding sharing identifiers obtained through the method, the connectivity between the two BSs and ACL functionality at the two BSs specific to a particular upper network and/or operator may be achieved.

### TECHNICAL FIELD

The non-limiting and example embodiments of the present disclosure generally relate to the technical field of mobile communication network, and specifically to methods and apparatuses for discovering an address of a Base Station (BS) in a mobile communication network.

### BACKGROUND

This section introduces aspects that may facilitate a better understanding of the disclosure. Accordingly, the statements of this section are to be read in this light and are not to be understood as admissions about what is in the prior art or what is not in the prior art.

For proper operation in a mobile communication network, two BSs in the network sometimes need to communicate with each other via a direct communication interface between the two BSs. However, one BS in the two BSs may only know a node identifier of the other BS, e.g., during the initial deployment of the BSs for the network. In this case, to set up the communication interface, the one BS needs to know a proper address of the other BS by manual configuration of the operator, or by discovering the address, with the help of a network node (which is responsible for e.g., managing the BSs) in the network.

For example, in a 4th Generation (4G) mobile communication network, an X2 control plane interface (X2-C) is defined between two neighbor eNBs. The control plane protocol stack of the X2 interface is shown on FIG. 1. The transport network layer is built on the Stream Control Transmission Protocol (SCTP) on top of the Internet Protocol (IP) layer. The application layer signalling protocol is referred to as X2-AP (X2 Application Protocol).

Likewise, in a 5th Generation (5G) mobile communication network, an Xn control plane interface (Xn-C) is defined between two Next Generation-Radio Access Network (NG-RAN) nodes. The control plane protocol stack of the Xn interface, which is similar to that of the X2 interface, is also shown on the FIG. 1. The transport network layer is built on the SCTP on top of the IP layer. The application layer signalling protocol is referred to as XnAP (Xn Application Protocol).

To build up an X2 or Xn interface between a first BS and a second BS, Transport Network Layer (TNL) addresses of the two BSs suitable for the SCTP connectivity are required. If the first BS wants to build up the X2 (in this case, the first BS also is called as a source BS) or Xn interface and does not know a proper address of the second BS (in this case, the second BS is also called as target BS), the address of the second BS could be configured manually by the operator in the first BS, or could be obtained by the first BS through a TNL address discovery procedure via a core network node.

Next, as an example, the current procedure for TNL Address Discovery for Xn interface will be described, but it is to be understood that the current procedure for TNL Address Discovery for X2 interface is similar.

Two messages, i.e., a UPLINK RAN CONFIGURATION TRANSFER message and a DOWNLINK RAN CONFIGURATION TRANSFER message, are used in the procedure for TNL Address Discovery. In the UPLINK RAN CONFIGURATION TRANSFER message, the source NG-RAN node queries the target NG-RAN node about the Xn target TNL address towards which an Xn Setup message will be sent. In the same message the source NG-RAN node also sends the source TNL address that it will use to send the Xn Setup message. The content generated by the source NG-RAN node in the UPLINK RAN CONFIGURATION TRANSFER message will be forwarded by a network node in the core network to the target NG-RAN node via the DOWNLINK RAN CONFIGURATION TRANSFER message.

The target NG-RAN node replies to the source NG-RAN node also via an UPLINK RAN CONFIGURATION TRANSFER message, in which the target TNL address for receiving the Xn Setup message is included. The content generated by the target NG-RAN node in the UPLINK RAN CONFIGURATION TRANSFER message will also be forwarded by the network node in the core network to the source NG-RAN node via a DOWNLINK RAN CONFIGURATION TRANSFER message.

The two messages and the TNL addresses (the source and target addresses) are described in 3rd Generation Partnership Project (3GPP) Technical Specification (TS) 38.413 Version 16.9.0 as follow (in italic font):

### 9.2.7.1 Uplink Ran Configuration Transfer

This message is sent by the NG-RAN node in order to transfer RAN configuration information.

Direction: NG-RAN node→AMF

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| SON Configuration | O | | 9.3.3.6 | | YES | ignore |
| Transfer | | | | | | |
| EN-DC SON | O | | OCTET | Contains the | YES | ignore |
| Configuration Transfer | | | STRING | EN-DC SON | | |
| | | | | Configuration | | |
| | | | | Transfer IE as | | |
| | | | | defined in TS | | |
| | | | | 36.413 [16]. | | |
| Inter-system SON | O | | 9.3.3.33 | | YES | ignore |
| Configuration Transfer | | | | | | |

### 9.2.7.2 Downlink Ran Configuration Transfer

This message is sent by the AMF in order to transfer RAN configuration information.

Direction: AMF→NG-RAN node

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| SON Configuration | O | | 9.3.3.6 | | YES | ignore |
| Transfer | | | | | | |
| EN-DC SON | O | | OCTET | Contains the | YES | ignore |
| Configuration Transfer | | | STRING | EN-DC SON | | |
| | | | | Configuration | | |
| | | | | Transfer IE as | | |
| | | | | defined in TS | | |
| | | | | 36.413 [16]. | | |
| Inter-system SON | O | | 9.3.3.33 | | YES | ignore |
| Configuration Transfer | | | | | | |

### 9.3.3.6 SON Configuration Transfer

This IE contains the configuration information, used by e.g., SON functionality, and additionally includes the NG-RAN node identifier of the destination of this configuration information and the NG-RAN node identifier of the source of this information.

| | | | IE type and | Semantics | | Assigned |
|---|---|---|---|---|---|---|
| IE/Group Name | Presence | Range | reference | description | Criticality | Criticality |
| Target RAN Node ID | M | | | | | |
| >Global RAN Node ID | M | | 9.3.1.5 | | | |
| >Selected TAI | M | | TAI | | | |
| | | | 9.3.3.11 | | | |
| >NG-RAN CGI | O | | 9.3.1.73 | This IE is ignored | YES | ignore |
| | | | | if the SON | | |
| | | | | Information IE | | |
| | | | | contains the SON | | |
| | | | | Information Reply | | |
| | | | | IE. | | |
| Source RAN Node ID | M | | | | | |
| >Global RAN Node ID | M | | 9.3.1.5 | | | |
| >Selected TAI | M | | TAI | | | |
| | | | 9.3.3.11 | | | |
| SON Information | M | | 9.3.3.7 | | | |
| Xn TNL Configuration | C-ifS | | 9.3.3.9 | Source NG-RAN | | |
| Info | ONInf | | | node Xn TNL | | |
| | ormat | | | Configuration | | |
| | ionRe | | | Info. | | |
| | quest | | | | | |

| Condition | Explanation |
|---|---|
| ifSONInformationRequest | This IE shall be present if the SON Information IE contains the |
| | SON Information Request IE set to “Xn TNL Configuration Info” |

### 9.3.3.7 SON Information

This IE identifies the nature of the configuration information transferred, i.e., a request, a reply or a report.

| | | | IE type and | Semantics | | Assigned |
|---|---|---|---|---|---|---|
| IE/Group Name | Presence | Range | reference | description | Criticality | Criticality |
| CHOICE SON | M | | | | — | |
| Information | | | | | | |
| >SON Information | | | | | | |
| Request | | | | | | |
| >>SON Information | M | | ENUMERATED | | — | |
| Request | | | (Xn TNL | | | |
| | | | Configuration | | | |
| | | | Info, . . . ) | | | |
| >SON Information | | | | | | |
| Reply | | | | | | |
| >>SON Information | M | | 9.3.3.8 | | — | |
| Reply | | | | | | |
| >SON Information | | | | | | |
| Report | | | | | | |
| >>SON Information | M | | 9.3.3.35 | | YES | ignore |
| Report | | | | | | |

### 9.3.3.8 SON Information Reply

This IE contains the configuration information to be replied to the NG-RAN node.

| | | | IE type and | Semantics |
|---|---|---|---|---|
| IE/Group Name | Presence | Range | reference | description |
| Xn TNL Configuration Info | O | | 9.3.3.9 | |

### 9.3.3.9 Xn TNL Configuration Info

This IE is used for signalling Xn TNL Configuration information for automatic Xn SCTP association establishment.

| | | | IE type and | Semantics | | Assigned |
|---|---|---|---|---|---|---|
| IE/Group Name | Presence | Range | reference | description | Criticality | Criticality |
| Xn Transport Layer | | 1 . . . < maxnoofX | | | — | |
| Addresses | | nTLAs> | | | | |
| >Transport Layer | M | | 9.3.2.4 | Transport Layer | — | |
| Address | | | | Addresses for | | |
| | | | | Xn SCTP | | |
| | | | | endpoint. | | |
| Xn Extended Transport | | 0 . . . < maxnoofX | | | — | |
| Layer Addresses | | nExtTLAs> | | | | |
| >IP-Sec Transport Layer | O | | Transport | Transport Layer | — | |
| Address | | | Layer | Addresses for | | |
| | | | Address | IP-Sec endpoint. | | |
| | | | 9.3.2.4 | | | |
| >Xn GTP Transport | | 0 . . . < maxnoofX | | | — | |
| Layer Addresses | | nGTP-TLAS> | | | | |
| >>GTP Transport Layer | M | | Transport | GTP Transport | — | |
| Address | | | Layer | Layer | | |
| | | | Address | Addresses for | | |
| | | | 9.3.2.4 | GTP end-points | | |
| | | | | (used for data | | |
| | | | | forwarding over | | |
| | | | | Xn). | | |
| >Xn SCTP Transport | | 0 . . . < maxnoofX | | | YES | ignore |
| Layer Addresses | | nTLAs> | | | | |
| >>Transport Layer | M | | Transport | Transport Layer | — | |
| Address SCTP | | | Layer | Addresses for | | |
| | | | Address | Xn SCTP | | |
| | | | 9.3.2.4 | endpoint. | | |

| Range bound | Explanation |
|---|---|
| maxnoofXnTLAs | Maximum no. of Xn Transport Layer Addresses for an SCTP end-point. |
| | Value is 2. |
| maxnoofXnExtTLAs | Maximum no. of Xn Extended Transport Layer Addresses in the message. |
| | Value is 16. |
| maxnoofXnGTP-TLAs | Maximum no. of Xn GTP Transport Layer Addresses for a GTP end-point |
| | in the message. Value is 16. |

As seen from the above contents, the Xn TNL Configuration Info Information Element (IE) includes up to two Xn transport layer addresses (In this disclosure, the term “transport layer address” refers to an address used for transport layer communication, which may be e.g., an IP address or an IP address and port number, where the IP address may be e.g., an IPv4 or IPv6 address).

The addresses of the BSs may be used not only for building up a communication interface between the BSs, but also for setting Access Control List (ACL) functionality. The ACL may be seen as a list for access control, by which the access to a BS from other BSs may be controlled. In case that the ACL functionality is applied in a BS, the BS may only accept connections from other BSs when the source addresses of the other BSs are allowed in the target BS. With the ACL, a target BS can admit traffic from the source TNL address, for example by configuring a firewall to allow reception of traffic from such sources.

Nowadays, a BS may have several addresses each of which may belong to a different upper network (e.g., a transport network or a network slice) built on infrastructure of the mobile communication network. This is because several operators may share infrastructure (e.g., BSs in the radio access network) of the mobile communication network, and each of the operators may build its own dedicated upper network on the infrastructure. Network sharing is a way for operators to share the heavy deployments costs for mobile network. The shared network operator allocates shared resources to the participating operators based on their planned and current needs and according to service level agreements. The shared resources may include radio resources.

For example, both LTE RAN and NR RAN support radio access network sharing and operators may share a common RAN. LTE RAN can be shared by up to six operators, and NR RAN can be shared by up to twelve operators.

The operators sharing the RAN equipment may still have separate transport networks with their own transport layer address plans. Therefore, it is required to assign dedicated transport network per each operator while the radio network is shared by multiple operators, e.g., by allowing multiple local SCTP endpoints configuration for each interface. An example network sharing situation is shown in FIG. 2, where four IP networks are assigned to four operators who share the radio access network.

### SUMMARY

The inventors of the present disclosure find, in the case that several operators share the mobile communication network, some problems will appear when the current procedure for TNL Address Discovery is employed.

For example, in 3GPP, the X2-C or Xn-C TNL Address discovery procedure is defined in order to find a target BS's transport layer address for X2-C or Xn-C interface establishment, as described above. However, there is no information that indicates which operator is using a TNL Address of SCTP end-point when sending the TNL address in the reply message. With this reason, there is confusion when setting up an X2-C or Xn-C interface within the same transport network for a specific operator by using transport layer address obtained by the TNL Address discovery procedure, if the RAN is shared by several operators and has multiple local SCTP endpoints configured for each operator.

An example current address discovery procedure in the case of network sharing is shown in FIG. 3. In this figure, a first BS (shown as “Source RAN” in the figure) is shared by operators A and B, a second BS (shown as “Target RAN” in the figure) is shared by operators A, B and C, and an X2-C or Xn-C interface could be required to be set up within a separate IP network (e.g., IP network A or B). However, the second BS (i.e., the “Target RAN”) will not reply to the TNL Address Discovery message with information that lists multiple SCTP endpoints possibly configured for different operators and/or different operator's subnets. Also, the first BS (i.e., the “Source RAN”) will not be aware of which operator IP network is available at the second BS. This creates a problem at the first BS on how to select its own source transport layer address among multiple SCTP endpoints possibly configured on a per sharing operator basis.

An additional problem is caused by the fact that the first BS will not specify in the TNL address discovery message the source address that will be used to send interface setup messages on a per sharing operator basis. This prevents correct use of the ACL function because the second BS is not able to correctly allow incoming traffic for the source transport layer addresses corresponding to each sharing operator. The same problem occurs when messages are sent from the second BS back to the first BS, and the second BS will not specify the TNL address to be used per sharing operator in the messages.

To resolve or alleviate the above problems, which is one of the objects of the present disclosure, the inventors of the present disclosure conceive of improving the address discovery procedure in the case of network sharing, by including not only one or more addresses, but also one or more corresponding sharing identifiers (corresponding to the one or more addresses respectively) into the request message and the reply message in the address discovery procedure, wherein the one or more corresponding sharing identifiers may enable the source BS and the target BS to identify which upper networks and/or which operators are sharing the underlying infrastructure of the mobile communication network, thus facilitating later establishment of connectivity between the two BSs and setup of ACL functionality in one or both of them in the case of network sharing.

According to a first aspect of the present disclosure, the object is achieved by a method performed by a first BS in a network, for discovering an address of a second BS in the network via a network node in the network, the method comprising: sending, to the network node, an address request message which includes a first list with one or more pairs of an address of the first BS and a corresponding sharing identifier; and receiving, from the network node, an address response message which includes a second list with one or more pairs of an address of the second BS and a corresponding sharing identifier.

According to a second aspect of the present disclosure, the object is achieved by a first BS in a network, for discovering an address of a second BS in the network via a network node in the network, the first BS comprising: a sending unit, for sending, to the network node, an address request message which includes a first list with one or more pairs of an address of the first BS and a corresponding sharing identifier; and a receiving unit, for receiving, from the network node, an address response message which includes a second list with one or more pairs of an address of the second BS and a corresponding sharing identifier.

According to a third aspect of the present disclosure, the object is achieved by a first BS in a network, comprising: a processor; and a memory, having stored instructions that when executed by the processor cause the first BS to perform the method according to the first aspect.

According to a fourth aspect of the present disclosure, the object is achieved by a machine readable medium having stored thereon instructions that when executed on a BS in a network cause the BS to perform the method according to the first aspect.

According to a fifth aspect of the present disclosure, the object is achieved by a method performed by a second BS in a network, for enabling a first BS in the network to discover an address of the second BS via a network node in the network, the method comprising: receiving, from the network node, an address request message which includes a first list with one or more pairs of an address of the first BS and a corresponding sharing identifier; and sending, to the network node, an address response message which includes a second list with one or more pairs of an address of the second BS and a corresponding sharing identifier.

According to a sixth aspect of the present disclosure, the object is achieved by a second BS in a network, for enabling a first BS in the network to discover an address of the second BS via a network node in the network, the second BS comprising: a receiving unit, for receiving, from the network node, an address request message which includes a first list with one or more pairs of an address of the first BS and a corresponding sharing identifier; and a sending unit, for sending, to the network node, an address response message which includes a second list with one or more pairs of an address of the second BS and a corresponding sharing identifier.

According to a seventh aspect of the present disclosure, the object is achieved by a second BS in a network, comprising: a processor; and a memory, having stored instructions that when executed by the processor cause the second BS to perform the method according to the fifth aspect.

According to an eighth aspect of the present disclosure, the object is achieved by a machine readable medium having stored thereon instructions that when executed on a second BS in a network cause the second BS to perform the method according to the fifth aspect.

In the case of network sharing, by using the addresses and the corresponding sharing identifiers obtained through the solution of the present disclosure, the source BS may establish connectivity specific to a particular upper network and/or operator with the target BS, and one of the two BSs may set ACL functionality specific to a particular upper network and/or operator with respect to the other of the two BSs.

### BRIEF DESCRIPTION OF THE DRAWINGS

The above and other aspects, features, and benefits of the present disclosure will become more fully apparent from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows the control plane protocol stack of the X2/Xn interface;

FIG. 2 shows an example network sharing situation, where four IP networks are assigned to four operators who share the radio access network;

FIG. 3 shows an example current address discovery procedure in the case of network sharing;

FIG. 4 illustrates a flowchart of a method performed by a first BS according to the present disclosure

FIG. 5 illustrates a flowchart of a method performed by a second BS according to the present disclosure;

FIG. 6 illustrates an example address discovery procedure according to the present disclosure;

FIG. 7 shows an example 4G architecture where the address discovery procedure according to the present disclosure may be applied;

FIG. 8 shows an example 5G architecture where the address discovery procedure according to the present disclosure may be applied;

FIG. 9 is a schematic block diagram of a first BS according to the present disclosure;

FIG. 10 is a schematic block diagram of a second BS according to the present disclosure;

FIG. 11 is another schematic block diagram of a first BS according to the present disclosure;

FIG. 12 is another schematic block diagram of a second BS according to the present disclosure.

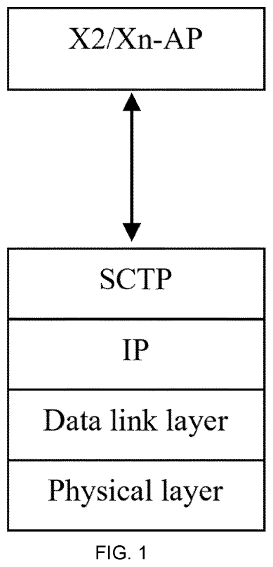

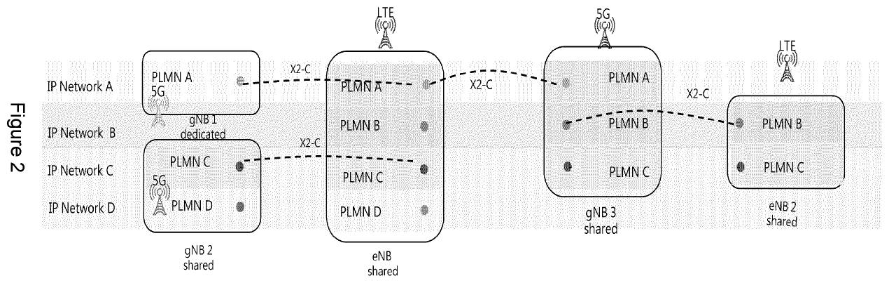

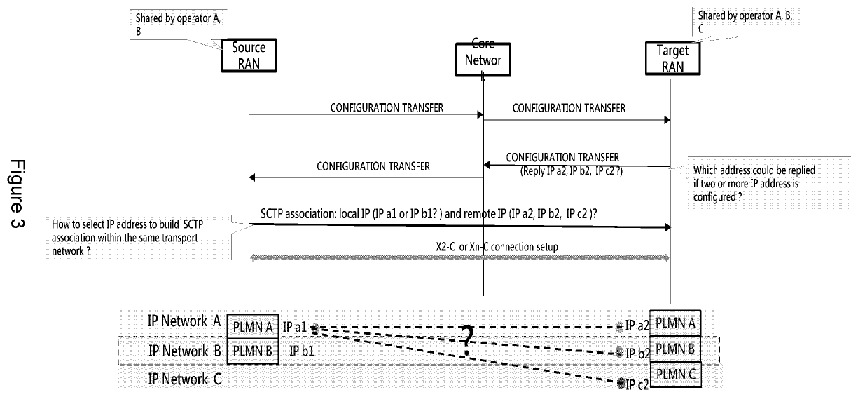

### DETAILED DESCRIPTION

Embodiments herein will be described more fully hereinafter with reference to the accompanying drawings. The embodiments herein may, however, be embodied in many different forms and should not be construed as limiting the scope of the appended claims.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., herein to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

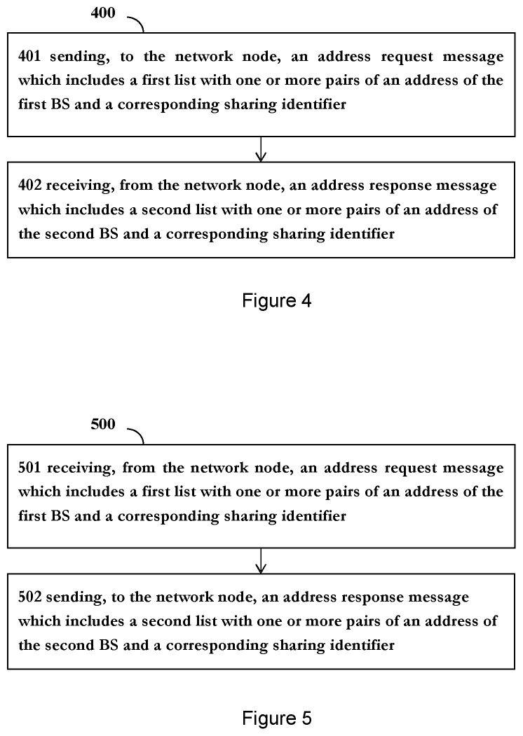

A flowchart of a method 400 performed by a first BS in a network for discovering an address of a second BS in the network via a network node in the network according to the present disclosure is shown in FIG. 4. The method 400 comprises: a step 401 of sending, to the network node, an address request message which includes a first list with one or more pairs of an address of the first BS and a corresponding sharing identifier; and a step 402 of receiving, from the network node, an address response message which includes a second list with one or more pairs of an address of the second BS and a corresponding sharing identifier.

A flow chart of a method 500 performed by a second BS in a network for enabling a first BS in the network to discover an address of the second BS via a network node in the network is shown in FIG. 5. The method 500 comprises: a step 501 of receiving, from the network node, an address request message which includes a first list with one or more pairs of an address of the first BS and a corresponding sharing identifier; and a step of 502 of sending, to the network node, an address response message which includes a second list with one or more pairs of an address of the second BS and a corresponding sharing identifier.

In an embodiment, a first address in the first list and a second address in the second list are to be selected by the first BS for establishing connectivity between the first BS and the second BS, wherein the first address and the second address correspond to a same sharing identifier. In this way, the first BS may establish connectivity specific to a particular upper network and/or operator with the second BS.

In an embodiment, an address in the first list is to be selected by the second BS based on a sharing identifier corresponding to the address in the first list, for setting ACL functionality with respect to the first BS, and/or an address in the second list is to be selected by the first BS based on a sharing identifier corresponding to the address in the second list, for setting ACL functionality with respect to the second BS. In this way, each of the two BSs may set ACL functionality specific to a particular upper network and/or operator with respect to the other of the two BSs.

Both the first BS and the second BS can include a network element on a dedicated hardware, a software instance or a firmware running on a hardware, a virtualized function instantiated on an appropriate platform (e.g. on a cloud infrastructure), and/or any combination thereof.

Now, further embodiments will be described in connection with a base station in 4G/5G network. It can be understood that, although the embodiments herein are described in the context of the 4G/5G network, the embodiments can be also applied in other mobile communication networks, if the same problems exist in their procedures of address discovery in the case of network sharing. It will be also understood that, although specific terms are used in the embodiments, the embodiments are not limited to those specific terms but may be applied to all similar entities. For example, the term “Base Station”/“BS” herein may refer to e.g., access point, base station, macro base station, femto base stations, NodeB (NB), eNodeB (eNB), gNodeB (gNB), en-gNB and so on.

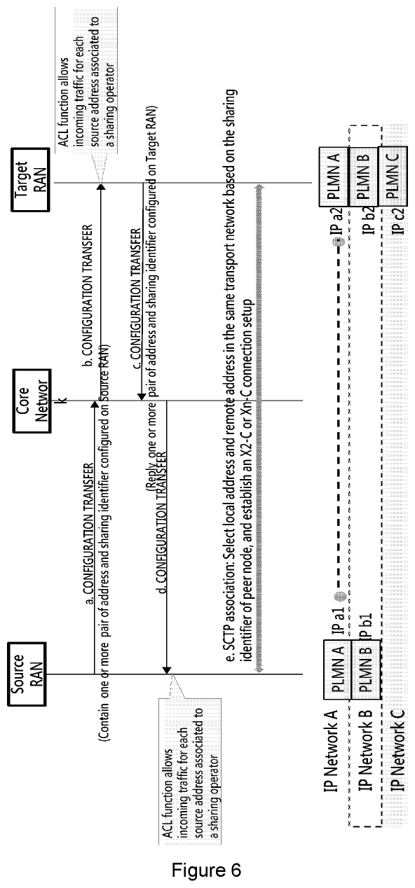

An example address discovery procedure according to the present disclosure is shown in FIG. 6. The address discovery procedure according to the present disclosure may be used preferably in the case of network sharing. However, even if the network is not shared, the address discovery procedure according to the present disclosure still can be used.

In step a in the figure, a first BS (shown as “Source RAN” in the figure) requests address of a second BS (shown as “Target RAN” in the figure) via a network node in the Core Network (simply shown as “Core Network” in the figure), by sending a UPLINK RAN CONFIGURATION TRANSFER message to the network node. The message includes a first list with one or more pairs of an address (e.g., a transport layer address) of the first BS and a corresponding sharing identifier to be used e.g., for an X2-C or Xn-C interface setup procedure.

In step b in the figure, the network node will forward the content of the UPLINK RAN CONFIGURATION TRANSFER message in a DOWNLINK RAN CONFIGURATION TRANSFER message to the second BS. After the second BS receives the DOWNLINK RAN CONFIGURATION TRANSFER message including the first list, the second BS may use the information in the first list to set ACL functionality with respect to the first BS. As an example, the ACL function at the second BS is able to “open up” traffic reception for an address in the first list associated to a particular operator, if the sharing identifier corresponding to the address refers to the particular operator. In this example, the traffic will be allowed to be received in the second BS only if it is associated to that address and that operator.

In step c in the figure, the second BS replies with its address via the network node, by sending a UPLINK RAN CONFIGURATION TRANSFER message to the network node. The message includes a second list with one or more pairs of an address (e.g., a transport layer address) of the second BS and a corresponding sharing identifier to be used e.g., for an X2-C or Xn-C interface setup procedure.

In step d in the figure, the network node will forward the content of the UPLINK RAN CONFIGURATION TRANSFER message in a DOWNLINK RAN CONFIGURATION TRANSFER message to the first BS. After the first BS receives the DOWNLINK RAN CONFIGURATION TRANSFER message including the second list, the first BS may also use the information in the second list to set ACL functionality with respect to the second BS. As an example, the ACL function at the first BS is able to “open up” traffic reception for an address in the second list associated to a particular operator, if the sharing identifier corresponding to the address refers to the particular operator. In this example, the traffic will be allowed to be received in the first BS only if it is associated to that address and that operator.

In step e after the address discovery procedure in the figure, the first BS may select a first address in the first list and a second address in the second list for establishing connectivity between the first BS and the second BS, wherein the first address and the second address correspond to a same sharing identifier. As an example, the first BS selects the proper TNL address of the second BS and its local source TNL address within a same transport network from the first list and the second list, then triggers an X2-C or Xn-C connection with the second node by using the selected addresses.

In an embodiment, the sharing identifier consists of one or more of:
a Public Land Mobile Network (PLMN) identifier;
an operator identifier;
a Non-Public Network (NPN) identifier;
a network slice identifier;
a Public Network Integrated Non-Public Networks (PNI-NPN) identifier.

In an embodiment, the address is a transport layer address or an IP-Sec transport layer address.

In an embodiment, the number of the addresses in each of the first list and the second list is up to a supportable maximum number of operators sharing the network.

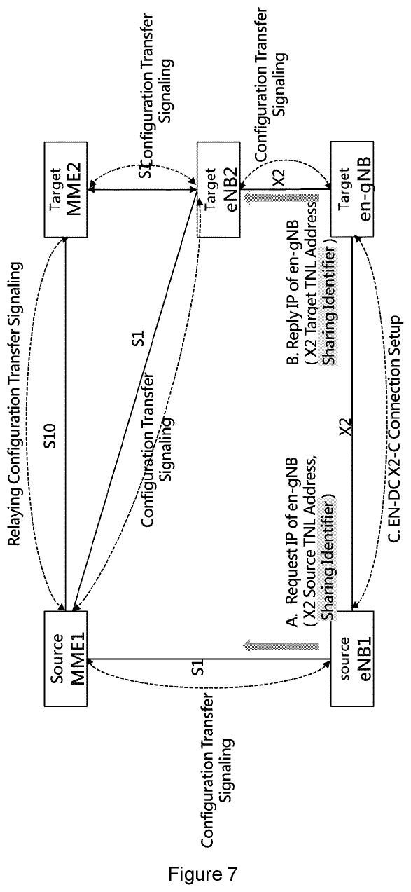

In an embodiment involving a 4G network, the network node is a Mobility Management Entity (MME), and the supportable maximum number is 6. An example 4G architecture where the address discovery procedure according to the present disclosure may be applied is shown in FIG. 7.

In a further embodiment involving a 4G network, each of the first list and the second list is included in an X2 TNL Configuration Info IE. This IE was defined in the 3GPP TS 36.413, and the inventors of the present disclosure suggest changing the IE as in table follow (wherein the underlined text in the table below indicates the suggested change):

TABLE 1
X2 TNL Configuration Info IE with suggested change

| IE/Group Name | Presence | Range |
|---|---|---|
| eNB X2 Transport Layer | | 1 . . . <maxnoofeNBX2TLAs> |
| Addresses | | |
| >Transport Layer Address | M | |
| > Sharing Identifier | O | |
| eNB X2 Extended | | 0 . . . <maxnoofeNBX2ExtTLAs> |
| Transport | | |
| Layer Addresses | | |
| >IP-Sec Transport Layer | O | |
| Address | | |
| >eNB GTP Transport | | 0 . . . |
| Layer Addresses | | <maxnoofeNBX2GTPTLAs> |
| >>GTP Transport Layer | M | |
| Address | | |
| eNB Indirect X2 Transport | | 0 . . . |
| Layer Addresses | | <maxnoofeNBX2TLAs> |
| >Transport Layer Address | O | |
| eNB X2 Extended | | 0 . . . |
| Transport | | <maxnoofeNBX2ExtTLAsSharing> |
| Layer Addresses for | | |
| Network Sharing | | |
| >Transport Layer Address | M | |
| > Sharing Identifier | O | |

| Range bound | Explanation |
|---|---|
| maxnoofeNBX2TLAs | Maximum no. of eNB X2 Transport |
| | Layer Addresses for an SCTP end-point. |
| | Value is 2. |
| maxnoofeNBX2ExtTLAs | Maximum no. of eNB X2 Extended |
| | Transport Layer Addresses in the |
| | message. Value is 16. |
| maxnoofeNBX2GTPTLAS | Maximum no. of eNB X2 GTP |
| | Transport Layer Addresses for an GTP |
| | end-point in the message. Value is 16. |
| maxnoofeNBX2ExtTLAsS | Maximum no. of eNB X2 Extended |
| haring | Transport Layer Addresses used for |
| | network sharing in the message. Value is 6. |

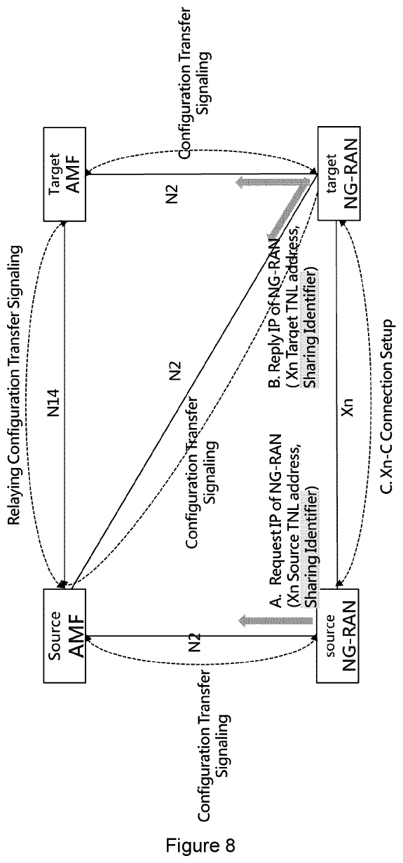

In an embodiment involving a 5G network, the network node is an Authentication Management Function (AMF), and the supportable maximum number is 12. An example 5G architecture where the address discovery procedure according to the present disclosure may be applied is shown in FIG. 8.

In a further embodiment involving a 5G network, each of the first list and the second list is included in an Xn TNL Configuration Info IE. This IE was defined in the 3GPP TS 38.413 Version 16.9.0, and the inventors of the present disclosure suggest changing the IE as in table 2 below (wherein the underlined text in the table below indicates the suggested change):

TABLE 2
Xn TNL Configuration Info IE with suggested change

| IE/Group Name | Presence | Range |
|---|---|---|
| Xn Transport Layer | | 1 . . . <maxnoofXnTLAs> |
| Addresses | | |
| >Transport Layer Address | M | |
| >Sharing Identifier | O | |
| Xn Extended Transport | | 0 . . . <maxnoofXnExtTLAs> |
| Layer Addresses | | |
| >IP-Sec Transport Layer | O | |
| Address | | |
| >Xn GTP Transport Layer | | 0 . . . <maxnoofXnGTP-TLAs> |
| Addresses | | |
| >>GTP Transport Layer | M | |
| Address | | |
| >Xn SCTP Transport Layer | | 0 . . . <maxnoofXnTLAs> |
| Addresses | | |
| >>Transport Layer Address | M | |
| SCTP | | |
| Xn Extended Transport | | 0 . . . |
| Layer Addresses for | | <maxnoofXnExtTLAsSharing> |
| Network Sharing | | |
| >Transport Layer Address | M | |
| >Sharing Identifier | O | |

| Range bound | Explanation |
|---|---|
| maxnoofXnTLAs | Maximum no. of Xn Transport |
| | Layer Addresses for an SCTP end-point. |
| | Value is 2. |
| maxnoofXnExtTLAs | Maximum no. of Xn Extended |
| | Transport Layer Addresses in the message. |
| | Value is 16. |
| maxnoofXnGTP-TLAs | Maximum no. of Xn GTP Transport |
| | Layer Addresses for a GTP end-point in |
| | the message. Value is 16. |
| maxnoofXnExtTLAsSharing | Maximum no. of Xn Extended |
| | Transport Layer Addresses used for network |
| | sharing in the message. Value is 12. |

As described above, the address may be an IP-Sec transport layer address. For example, it is also possible to support a use case where the sharing operators decide to use separate transport subnets for the configuration of IP-Sec connections. In this case, the inventors of the present disclosure suggest another change to the current IEs (which could be applied together with the suggested changes above) as in table 3 and table 4 below (wherein the underlined text in the tables below indicates the suggested changes):

TABLE 3
X2 TNL Configuration Info IE with another suggested change

| IE/Group Name | Presence | Range |
|---|---|---|
| eNB X2 Transport Layer | | 1 . . . <maxnoofeNBX2TLAs> |
| Addresses | | |
| >Transport Layer Address | M | |
| >Sharing Identifier | O | |
| eNB X2 Extended Transport | | 0 . . . |
| Layer Addresses | | <maxnoofeNBX2ExtTLAs> |
| >IP-Sec Transport Layer | O | |
| Address | | |
| >Sharing Identifier | O | |
| >eNB GTP Transport Layer | | 0 . . . |
| Addresses | | <maxnoofeNBX2GTPTLAs> |
| >>GTP Transport Layer | M | |
| Address | | |
| eNB Indirect X2 Transport | | 0 . . . <maxnoofeNBX2TLAs> |
| Layer Addresses | | |
| >Transport Layer Address | O | |

| Range bound | Explanation |
|---|---|
| maxnoofeNBX2TLAs | Maximum no. of eNB X2 Transport |
| | Layer Addresses for an SCTP end-point. |
| | Value is 2. |
| maxnoofeNBX2ExtTLAs | Maximum no. of eNB X2 Extended |
| | Transport Layer Addresses in the |
| | message. Value is 16. |
| maxnoofeNBX2GTPTLAs | Maximum no. of eNB X2 GTP |
| | Transport Layer Addresses for an GTP |
| | end-point in the message. Value is 16. |

TABLE 4
Xn TNL Configuration Info IE with another suggested change

| IE/Group Name | Presence | Range |
|---|---|---|
| Xn Transport Layer | | 1 . . . <maxnoofXnTLAs> |
| Addresses | | |
| >Transport Layer Address | M | |
| >Sharing Identifier | O | |
| Xn Extended Transport | | 0 . . . <maxnoofXnExtTLAs> |
| Layer Addresses | | |
| >IP-Sec Transport Layer | O | |
| Address | | |
| >Sharing Identifier | O | |
| >Xn GTP Transport Layer | | 0 . . . <maxnoofXnGTP-TLAs> |
| Addresses | | |
| >>GTP Transport Layer | M | |
| Address | | |
| >Xn SCTP Transport Layer | | 0 . . . <maxnoofXnTLAs> |
| Addresses | | |
| >>Transport Layer Address | M | |
| SCTP | | |

| Range bound | Explanation |
|---|---|
| maxnoofXnTLAs | Maximum no. of Xn Transport Layer |
| | Addresses for an SCTP end-point. |
| | Value is 2. |
| maxnoofXnExtTLAs | Maximum no. of Xn Extended |
| | Transport Layer Addresses in the |
| | message. Value is 16. |
| maxnoofXnGTP-TLAS | Maximum no. of Xn GTP |
| | Transport Layer Addresses for a GTP |
| | end-point in the message. Value is 16. |

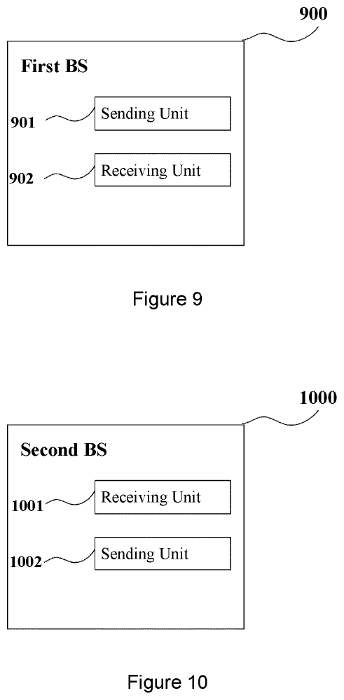

FIG. 9 illustrates a schematic block diagram of a first BS 900 in a network according to the present disclosure. The first BS 900 may be used for discovering an address of a second BS in the network via a network node in the network, and may include: a sending unit 901, for sending, to the network node, an address request message which includes a first list with one or more pairs of an address of the first BS and a corresponding sharing identifier; and a receiving unit 902, for receiving, from the network node, an address response message which includes a second list with one or more pairs of an address of the second BS and a corresponding sharing identifier.

FIG. 10 illustrates a schematic block diagram of a second BS 1000 in a network according to the present disclosure. The second BS 1000 may be used for enabling a first BS in the network to discover an address of the second BS via a network node in the network, and may include: a receiving unit 1001, for receiving, from the network node, an address request message which includes a first list with one or more pairs of an address of the first BS and a corresponding sharing identifier; and a sending unit 1002, for sending, to the network node, an address response message which includes a second list with one or more pairs of an address of the second BS and a corresponding sharing identifier.

It can be appreciated that, each of the first BS 900 and the second BS 1000 described herein may be implemented by various units, so that either the first BS 900 or the second BS 1000 implementing one or more functions described with the embodiments may comprise not only the units shown in the corresponding figure, but also other units for implementing one or more functions thereof. In addition, each of the first BS 900 and the second BS 1000 may comprise a single unit configured to perform two or more functions, or separate units for each separate function. Moreover, the units may be implemented in hardware, firmware, software, or any combination thereof.

It is understood that blocks of the block diagrams and/or flowchart illustrations, and combinations of blocks in the block diagrams and/or flowchart illustrations, may be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

It is also to be understood that the functions/acts noted in the blocks of the flowchart may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Furthermore, the solution of the present disclosure may take the form of a computer program on a memory having computer-usable or computer-readable program code embodied in the medium for use by or in connection with an instruction execution system. In the context of this document, a memory may be any medium that may contain, store, or is adapted to communicate the program for use by or in connection with the instruction execution system, apparatus, or device.

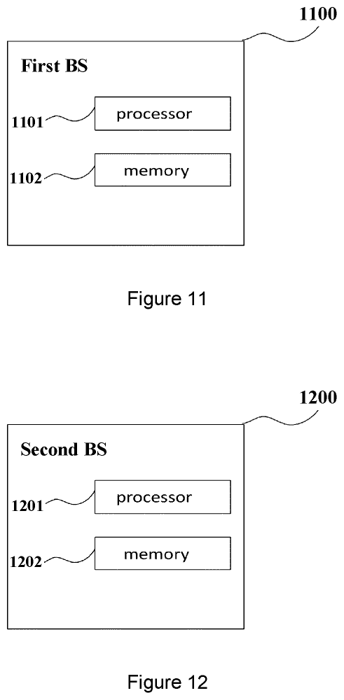

Therefore, the present disclosure also provides a first BS 1100 including a processor 1101 and a memory 1102, as shown in FIG. 11. In the first BS 1100, the memory 1102 stores instructions that when executed by the processor 1101 cause the first BS 1100 to perform the method of the first BS described above with the embodiments. In addition, the present disclosure provides a second BS 1200 of a base station including a processor 1201 and a memory 1202, as shown in FIG. 12. In the second BS 1200, the memory 1202 stores instructions that when executed by the processor 1201 cause the second BS 1200 to perform the method of the second BS described above with the embodiments.

The present disclosure also provides a machine readable medium (not illustrated) having stored thereon instructions that when executed on a first BS cause the first BS to perform the method of the first BS described with the above embodiments. Moreover, the present disclosure provides a machine readable medium (not illustrated) having stored thereon instructions that when executed on a second BS cause the second BS to perform the method of the second BS described with the above embodiments.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by a first Base Station (BS) in a network, for discovering an address of a second BS in the network via a network node in the network, the method comprising:
sending, to the network node, an address request message which includes a first list with one or more pairs of an address of the first BS and a corresponding sharing identifier; and
receiving, from the network node, an address response message which includes a second list with one or more pairs of an address of the second BS and a corresponding sharing identifier.

2. The method of claim 1, wherein a first address in the first list and a second address in the second list are to be selected by the first BS for establishing connectivity between the first BS and the second BS, wherein the first address and the second address correspond to a same sharing identifier.

3. The method of claim 1, wherein an address in the first list is to be selected by the second BS based on a sharing identifier corresponding to the address in the first list, for setting Access Control List (ACL) functionality with respect to the first BS, and/or
an address in the second list is to be selected by the first BS based on a sharing identifier corresponding to the address in the second list, for setting ACL functionality with respect to the second BS.

4. The method of claim 1, wherein the sharing identifier consists of one or more of:
a Public Land Mobile Network (PLMN) identifier;
an operator identifier;
a Non-Public Network (NPN) identifier;
a network slice identifier;
a Public Network Integrated Non-Public Networks (PNI-NPN) identifier.

5. The method claim 1, wherein the address is a transport layer address or an IP-Sec transport layer address.

6. The method of claim 1, wherein the number of the addresses in each of the first list and the second list is up to a supportable maximum number of operators sharing the network.

7. The method of claim 1, wherein the network node is a Mobility Management Entity (MME), and the supportable maximum number is 6.

8. The method of claim 7, wherein each of the first list and the second list is included in an X2 TNL Configuration Info Information Element (IE).

9. The method of claim 1, wherein the network node is an Authentication Management Function (AMF), and the supportable maximum number is 12.

10. The method of claim 9, wherein each of the first list and the second list is included in an Xn TNL Configuration Info IE.

11. A method performed by a second Base Station (BS) in a network, for enabling a first BS in the network to discover an address of the second BS via a network node in the network, the method comprising:
receiving, from the network node, an address request message which includes a first list with one or more pairs of an address of the first BS and a corresponding sharing identifier; and
sending, to the network node, an address response message which includes a second list with one or more pairs of an address of the second BS and a corresponding sharing identifier.

12. The method of claim 11, wherein a first address in the first list and a second address in the second list are to be selected by the first BS for establishing connectivity between the first BS and the second BS, wherein the first address and the second address correspond to a same sharing identifier.

13. The method of claim 11, wherein an address in the first list is to be selected by the second BS based on a sharing identifier corresponding to the address in the first list, for setting Access Control List (ACL) functionality with respect to the first BS, and/or
an address in the second list is to be selected by the first BS based on a sharing identifier corresponding to the address in the second list, for setting ACL functionality with respect to the second BS.

14. The method of claim 11, wherein the sharing identifier consists of one or more of:
a Public Land Mobile Network (PLMN) identifier;
an operator identifier;
a Non-Public Network (NPN) identifier;
a network slice identifier;
a Public Network Integrated Non-Public Networks (PNI-NPN) identifier.

15. The method of claim 11, wherein the address is a transport layer address or an IP-Sec transport layer address.

16. The method of claim 11, wherein the number of the addresses in each of the first list and the second list is up to a supportable maximum number of operators sharing the network.

17. The method of claim 11, wherein the network node is a Mobility Management Entity (MME), and the supportable maximum number is 6.

18. The method of claim 17, wherein each of the first list and the second list is included in an X2 TNL Configuration Info Information Element (IE).

19. The method of claim 11, wherein the network node is an Authentication Management Function (AMF), and the supportable maximum number is 12.

20. (canceled)

21. A first BS in a network, comprising:
a processor; and
a memory, having stored instructions that when executed by the processor cause the first BS to:
send, to the network node, an address request message which includes a first list with one or more pairs of an address of the first BS and a corresponding sharing identifier; and
receive, from the network node, an address response message which includes a second list with one or more pairs of an address of the second BS and a corresponding sharing identifier.

22.-24. (canceled)
